(19) United States
(12) Patent Application Publication
(10) Pub. No.: US 2013/0175810 A1
(43) Pub. Date: Jul. 11, 2013

(54) CONTROL DEVICE FOR STARTER AND METHOD OF CONTROLLING STARTER

(71) Applicants: Kouki Moriya, Aichi-gun (JP); Jumpei Kakehi, Toyota-shi (JP); Hasrul Sany Bin Hashim, Toyota-shi (JP)

(72) Inventors: Kouki Moriya, Aichi-gun (JP); Jumpei Kakehi, Toyota-shi (JP); Hasrul Sany Bin Hashim, Toyota-shi (JP)

(73) Assignee: TOYOTA JIDOSHA KABUSHIKI KAISHA, Toyota-shi (JP)

(21) Appl. No.: 13/699,388

(22) PCT Filed: Jul. 22, 2010
(86) PCT No.: PCT/JP10/62321

§ 371 Date: Mar. 20, 2013

(51) Int. Cl. F02N 11/08

(52) U.S. Cl. CPC F02N 11/0855
USPC 290/38 R

(57) ABSTRACT

An ECU executes a program including the steps of selecting a rotation mode in a case where a request to start an engine has been made and an engine rotation speed is equal to or lower than α2 and greater than α1, selecting a full drive mode, stopping a motor and an actuator in a case where engagement between a pinion gear of a starter and a ring gear of the engine is defective, and selecting an engagement mode in a case where a motor rotation speed Nm is equal to or lower than A and an engine rotation speed Ne is equal to or lower than.

### TECHNICAL FIELD

The present invention relates to a control device for a starter and a method of controlling a starter and particularly to a technique for controlling a starter, with which an actuator for moving a pinion gear so as to be engaged with a ring gear provided around an outer circumference of a flywheel of an engine and a motor for rotating the pinion gear are individually controlled.

### BACKGROUND ART

In recent years, in order to improve fuel efficiency or reduce exhaust emission, some cars having an internal combustion engine such as an engine include what is called an idling-stop function, in which an engine is automatically stopped while a vehicle stops and a driver operates a brake pedal, and the vehicle is automatically re-started, for example, by a driver's operation for re-start such as decrease in an amount of operation of a brake pedal to zero.

In this idling-stop, the engine may be re-started while an engine rotation speed is relatively high. In such a case, with a conventional starter in which pushing-out of a pinion gear for rotating the engine and rotation of the pinion gear are caused by one drive command, the starter is driven after waiting until the engine rotation speed sufficiently lowers, in order to facilitate engagement between the pinion gear and a ring gear of the engine. Then, a time lag is caused between issuance of a request to re-start an engine and actual engine cranking, and the driver may feel uncomfortable.

In order to solve such a problem, Japanese Patent Laying-Open No. 2005-330813 (PTL 1) discloses a technique for causing a pinion gear to perform a rotational operation with the use of a starter configured such that a pinion gear engagement operation and a pinion gear rotational operation can independently be performed prior to the pinion gear engagement operation when a re-start request is issued while rotation of an engine is being lowered immediately after a stop request is generated and for re-starting the engine by causing the pinion gear engagement operation when a pinion gear rotation speed is in synchronization with an engine rotation speed.

### CITATION LIST

### Patent Literature

PTL 1: Japanese Patent Laying-Open No. 2005-330813

### SUMMARY OF INVENTION

### Technical Problem

If the engine rotation speed suddenly fluctuates before a pinion gear engagement operation in an example where the pinion gear engagement operation is performed when the pinion gear rotation speed and the engine rotation speed are in synchronization as in the technique described in Japanese Patent Laying-Open No. 2005-330813, however, it becomes difficult to synchronize the pinion gear rotation speed and the engine rotation speed with each other. Therefore, starting capability of the engine may become poor.

The present invention was made to solve the above-described problems, and an object thereof is to provide a control device for a starter and a method of controlling a starter, for suppressing deterioration in starting capability of an engine.

### Solution to Problem

A control device for a starter according to one aspect of this invention is a control device for a starter for starting an engine. The starter includes a second gear that can be engaged with a first gear coupled to a crankshaft of the engine, an actuator for moving the second gear to a position of engagement with the first gear in a driven state, and a motor for rotating the second gear. The control device is capable of individually driving each of the actuator and the motor. The control device has a rotation mode in which the motor is driven prior to drive of the actuator and an engagement mode in which the second gear is engaged with the first gear by driving the actuator prior to drive of the motor. The control device lowers a rotation speed of the motor and selects the engagement mode when start of the engine failed in the rotation mode.

Preferably, the control device selects the engagement mode and controls the actuator and the motor such that the engine starts after the motor is stopped, when the rotation mode was selected and start of the engine failed.

Further preferably, the control device controls the actuator and the motor such that the engine starts in the engagement mode when such a condition for allowing engagement between the first gear and the second gear that a rotation speed of the motor is equal to or lower than a first threshold value and a rotation speed of the engine is equal to or lower than a second threshold value is satisfied.

Further preferably, the control device determines that start of the engine failed when such a state that a difference between a rotation speed of the motor and a rotation speed of the engine is out of a predetermined range has continued for a predetermined period of time while the motor and the actuator have been operating.

Further preferably, the control device selects the rotation mode when the rotation speed of the engine is higher than a reference value in a case where a request for starting the engine is issued and selects the engagement mode when the rotation speed of the engine is lower than the reference value in a case where the request for starting the engine is issued.

A starter in a method of controlling a starter according to another aspect of this invention includes a second gear that can be engaged with a first gear coupled to a crankshaft of an engine, an actuator for moving the second gear to a position of engagement with the first gear in a driven state, and a motor for rotating the second gear. Each of the actuator and the motor can individually be driven. This method includes the steps of driving the actuator and the motor in a rotation mode in which the motor is driven prior to drive of the actuator, driving the actuator and the motor in an engagement mode in which the second gear is engaged with the first gear by driving the actuator prior to drive of the motor, and lowering a rotation speed of the motor and selecting the engagement mode when start of the engine failed in the rotation mode.

### Advantageous Effects of Invention

According to the present invention, when start of the engine is completed in the rotation mode, the engine can be started promptly even though the engine rotation speed is high. In addition, even when start of the engine fails in the rotation mode, the engine can reliably be started in the engagement mode, so that deterioration in engine starting capability can be suppressed. Therefore, a control device for a starter and a method of controlling a starter for suppressing deterioration in engine starting capability can be provided.

### BRIEF DESCRIPTION OF DRAWINGS

FIG. 1 is an overall block diagram of a vehicle.

FIG. 2 is a functional block diagram of an ECU.

FIG. 3 is a diagram for illustrating transition of an operation mode of a starter.

FIG. 4 is a diagram for illustrating a drive mode in an engine start operation.

FIG. 5 is a flowchart showing a control structure of processing performed by the ECU.

### DESCRIPTION OF EMBODIMENTS

An embodiment of the present invention will be described hereinafter with reference to the drawings. In the description below, the same elements have the same reference characters allotted. Their label and function are also identical. Therefore, detailed description thereof will not be repeated.

[Structure of Engine Starting Device]

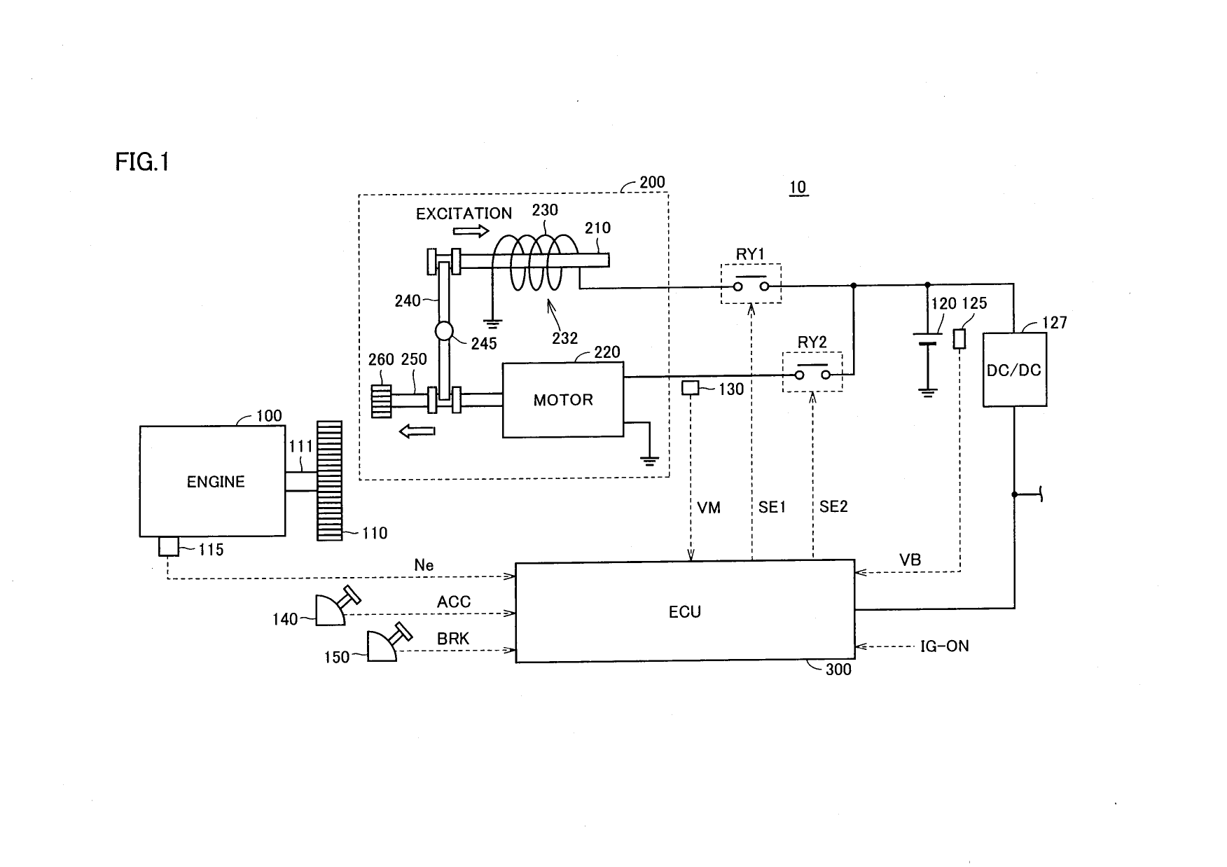

FIG. 1 is an overall block diagram of a vehicle 10. Referring to FIG. 1, vehicle 10 includes an engine 100, a battery 120, a starter 200, a control device (hereinafter also referred to as an ECU) 300, and relays RY1, RY2. In addition, starter 200 includes a motor 220, an actuator 232, a coupling portion 240, an output member 250, and a pinion gear 260. Moreover, actuator 232 includes a plunger 210 and a solenoid 230.

Engine 100 generates driving force for running vehicle 10. A crankshaft 111 serving as an output shaft of engine 100 is connected to a drive wheel, with a powertrain structured to include a clutch, a reduction gear, or the like being interposed.

Engine 100 is provided with a rotation speed sensor 115. Rotation speed sensor 115 detects a rotation speed Ne of engine 100 and outputs a detection result to ECU 300.

Battery 120 is an electric power storage element configured such that it can be charged and can discharge. Battery 120 is configured to include a secondary battery such as a lithium ion battery, a nickel metal hydride battery, a lead-acid battery, or the like. Alternatively, battery 120 may be implemented by a power storage element such as an electric double layer capacitor.

Battery 120 is connected to starter 200 with relays RY1, RY2 controlled by ECU 300 being interposed. Battery 120 supplies a supply voltage for driving to starter 200 as relays RY1, RY2 are closed. It is noted that a negative electrode of battery 120 is connected to a body earth of vehicle 10.

Battery 120 is provided with a voltage sensor 125. Voltage sensor 125 detects an output voltage VB of battery 120 and outputs a detection value to ECU 300.

The voltage of battery 120 is supplied to ECU 300 and auxiliary machinery such as an inverter of an air-conditioning apparatus through a DC/DC converter 127. DC/DC converter 127 is controlled by ECU 300 so as to maintain a voltage supplied to ECU 300 and the like. For example, in view of the fact that the voltage of battery 120 temporarily lowers as a result of drive of motor 220 for cranking engine 100, DC/DC converter 127 is controlled so as to raise the voltage when motor 220 is driven.

As will be described later, since motor 220 is controlled to be driven while a signal requesting start of engine 100 is output, DC/DC converter 127 is controlled to raise a voltage while the signal requesting start of engine 100 is output. A method of controlling DC/DC converter 127 is not limited thereto.

Relay RY1 has one end connected to a positive electrode of battery 120 and the other end connected to one end of solenoid 230 within starter 200. Relay RY1 is controlled by a control signal SE1 from ECU 300 so as to switch between supply and cut-off of a supply voltage from battery 120 to solenoid 230.

Relay RY2 has one end connected to the positive electrode of battery 120 and the other end connected to motor 220 within starter 200. Relay RY2 is controlled by a control signal SE2 from ECU 300 so as to switch between supply and cut-off of a supply voltage from battery 120 to motor 220. In addition, a voltage sensor 130 is provided in a power line connecting relay RY2 and motor 220 to each other. Voltage sensor 130 detects a motor voltage VM and outputs a detection value to ECU 300.

In the present embodiment, starter 200 includes a second gear that can be engaged with a first gear coupled to crankshaft 111 of engine 100, actuator 232 for moving the second gear to a position of engagement with the first gear in a driven state, and motor 220 for rotating the second gear. The “first gear” in the present embodiment is a ring gear 110 coupled to crankshaft 111 of engine 100, and the “second gear” is pinion gear 260.

As described above, supply of a supply voltage to motor 220 and solenoid 230 within starter 200 can independently be controlled by relays RY1, RY2.

Output member 250 is coupled to a rotation shaft of a rotor (not shown) within the motor, for example, by a straight spline or the like. In addition, pinion gear 260 is provided on an end portion of output member 250 opposite to motor 220. As relay RY2 is closed, the supply voltage is supplied from battery 120 so as to rotate motor 220. Then, output member 250 transmits the rotational operation of the rotor to pinion gear 260, to thereby rotate pinion gear 260.

As described above, solenoid 230 has one end connected to relay RY1 and the other end connected to the body earth. As relay RY1 is closed and solenoid 230 is excited, solenoid 230 attracts plunger 210 in a direction of arrow.

Plunger 210 is coupled to output member 250 with coupling portion 240 being interposed. As solenoid 230 is excited, plunger 210 is attracted in the direction of the arrow. Thus, coupling portion 240 of which fulcrum 245 is fixed moves output member 250 from a stand-by position shown in FIG. 1 in a direction reverse to a direction of operation of plunger 210, that is, a direction in which pinion gear 260 moves away from a main body of motor 220. In addition, biasing force reverse to the arrow in FIG. 1 is applied to plunger 210 by a not-shown spring mechanism, and when solenoid 230 is no longer excited, it returns to the stand-by position.

As output member 250 thus operates in an axial direction as a result of excitation of solenoid 230, pinion gear 260 is engaged with ring gear 110 provided around an outer circumference of a flywheel attached to crankshaft 111 of engine 100. Then, as pinion gear 260 performs a rotational operation while pinion gear 260 and ring gear 110 are engaged with each other, engine 100 is cranked and started.

Thus, in the present embodiment, actuator 232 for moving pinion gear 260 so as to be engaged with ring gear 110 provided around the outer circumference of the flywheel of engine 100 and motor 220 for rotating pinion gear 260 are individually controlled.

Though not shown in FIG. 1, a one-way clutch may be provided between output member 250 and the rotor shaft of motor 220 such that the rotor of motor 220 does not rotate due to the rotational operation of ring gear 110.

In addition, actuator 232 in FIG. 1 is not limited to the mechanism as above so long as it is a mechanism capable of transmitting rotation of pinion gear 260 to ring gear 110 and switching between a state that pinion gear 260 and ring gear 110 are engaged with each other and a state that they are not engaged with each other. For example, such a mechanism that pinion gear 260 and ring gear 110 are engaged with each other as a result of movement of the shaft of output member 250 in a radial direction of pinion gear 260 is also applicable.

ECU 300 includes a CPU (Central Processing Unit), a storage device, and an input/output buffer, none of which is shown, and receives input from each sensor or provides output of a control command to each piece of equipment. It is noted that control of these components is not limited to processing by software, and a part thereof may also be constructed by dedicated hardware (electronic circuitry) and processed.

ECU 300 receives a signal ACC indicating an amount of operation of an accelerator pedal 140 from a sensor (not shown) provided on accelerator pedal 140. ECU 300 receives a signal BRK indicating an amount of operation of a brake pedal 150 from a sensor (not shown) provided on brake pedal 150. In addition, ECU 300 receives a start operation signal IG-ON issued in response to a driver's ignition operation or the like. Based on such information, ECU 300 generates a signal requesting start of engine 100 and a signal requesting stop thereof and outputs control signal SE1, SE2 in accordance therewith, so as to control an operation of starter 200.

ECU 300 can individually cause drive of each of actuator 232 and motor 220. In addition, ECU 300 has a rotation mode in which motor 220 is driven prior to drive of actuator 232 and an engagement mode in which pinion gear 260 is engaged with ring gear 110 by driving actuator 232 prior to drive of motor 220.

In the present embodiment, when start of engine 100 failed in the rotation mode, ECU 300 lowers the rotation speed of motor 220 and selects the engagement mode.

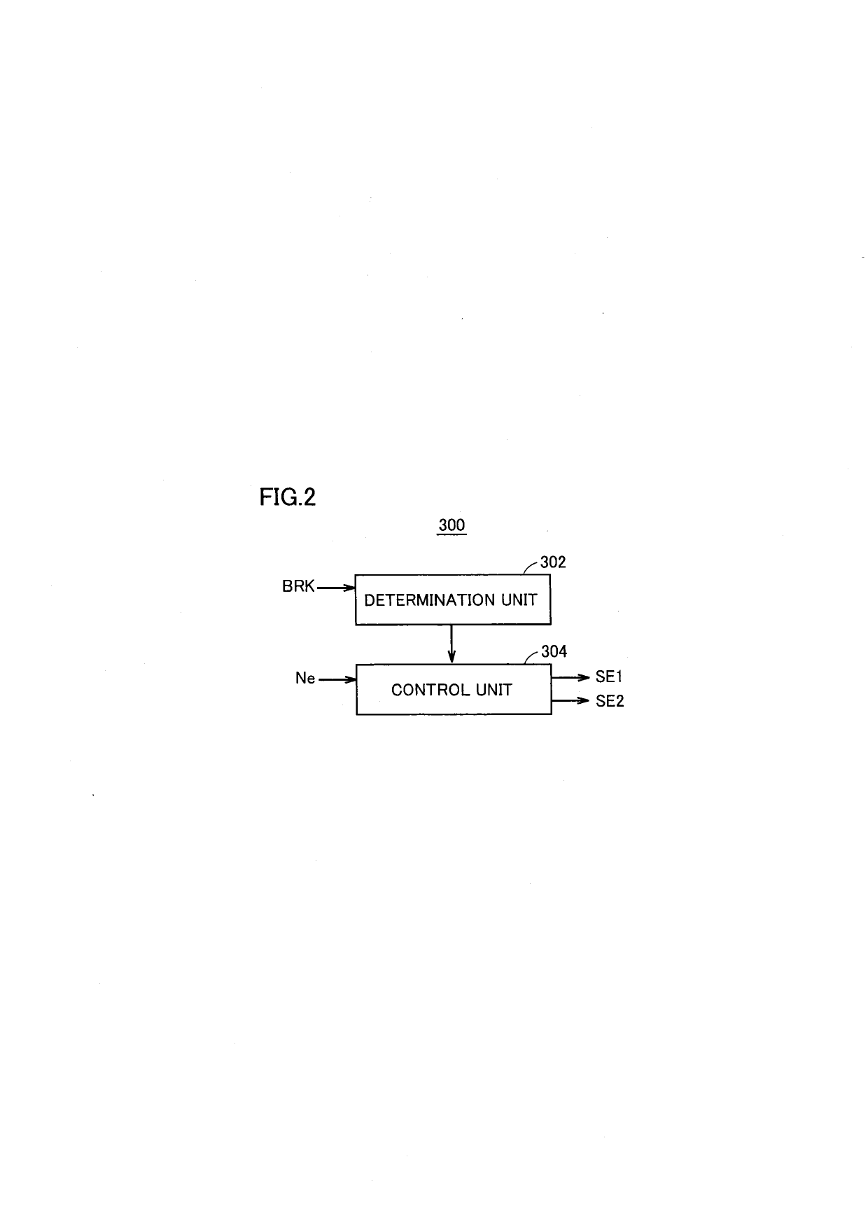

Referring to FIG. 2, a function of ECU 300 will be described. It is noted that a function of ECU 300 described below may be implemented by software or hardware or by cooperation of software and hardware.

ECU 300 includes a determination unit 302 and a control unit 304. Determination unit 302 determines whether start of engine 100 has been requested or not. For example, when an amount of operation of brake pedal 150 by the driver decreases to zero, determination unit 302 determines that start of engine 100 has been requested. More specifically, when the amount of operation of brake pedal 150 by the driver decreases to zero while engine 100 and vehicle 10 remain stopped, determination unit 302 determines that start of engine 100 has been requested. A method of determination as to whether or not start of engine 100 has been requested that is made by determination unit 302 is not limited thereto. When control unit 304 determines that start of engine 100 has been requested, control unit 304 controls actuator 212 and motor 220 by generating a signal requesting start of engine 100 and outputting control signal SE1, SE2 in accordance therewith.

In the present embodiment, when a signal requesting start of engine 100 is generated, that is, when it is determined that start of engine 100 has been requested, control unit 304 controls actuator 232 and motor 220 so as to start engine 100, by selecting any one of a plurality of control modes based on rotation speed Ne of engine 100. The plurality of control modes include a first mode in which actuator 232 and motor 220 are controlled such that pinion gear 260 starts rotation after pinion gear 260 moves toward ring gear 110 and a second mode in which actuator 232 and motor 220 are controlled such that pinion gear 260 moves toward ring gear 110 after pinion gear 260 starts rotation.

When control unit 304 selected the first mode, control unit 304 controls actuator 232 such that pinion gear 260 moves toward ring gear 110 when determination unit 302 determined that start of engine 100 has been requested and control unit 304 controls motor 220 such that pinion gear 260 rotates after pinion gear 260 moved toward ring gear 110.

When control unit 304 selected the second mode, control unit 304 controls motor 220 such that pinion gear 260 starts rotation when determination unit 302 determined that start of engine 100 has been requested and control unit 304 controls actuator 232 such that pinion gear 260 moves toward ring gear 110 after pinion gear 260 started rotation.

When start of engine 100 has been requested and rotation speed Ne of engine 100 is equal to or smaller than a first predetermined reference value α1, control unit 304 selects the first mode. When start of engine 100 has been requested and rotation speed Ne of engine 100 is greater than first reference value α1, control unit 304 selects the second mode.

When start of engine 100 failed, control unit 304 selects the first mode and controls actuator 232 and motor 220 such that engine 100 starts, after it stops drive of motor 220.

In particular, the present embodiment is characterized in that, when control unit 304 selected the second mode and start of engine 100 failed, control unit 304 selects the first mode instead of the second mode and controls actuator 232 and motor 220 such that engine 100 starts, after it stops drive of motor 220.

Control unit 304 determines that start of engine 100 has failed when such a state that a difference (Nm−Ne) between a rotation speed Nm of motor 220 and rotation speed Ne of engine 100 is out of a predetermined range (greater than a predetermined value Nerr) has continued for a predetermined period of time while motor 220 and actuator 232 have been operating in parallel. It is noted that control unit 304 may detect rotation speed Nm of motor 200 with a not-shown rotation speed sensor or it may estimate rotation speed Nm of motor 220 by using a time period during which motor 220 has been driven and a map, an equation, a table, or the like. A map, an equation, a table, or the like shows relation between a time period during which motor 220 has been driven and rotation speed Nm of motor 220, and it is predetermined, for example, in terms of design or through experiments. In addition, rotation speed Nm of motor 220 refers to a rotation speed converted to a rotation speed of crankshaft 111 of engine 100 based on a gear ratio between pinion 260 and ring gear 110.

When control unit 304 determines that start of engine 100 has failed, it stops drive of motor 220 until rotation speed Nm of motor 220 is equal to or lower than a first threshold value and rotation speed Ne of engine 100 is equal to or lower than a second threshold value.

When rotation speed Nm of motor 220 is equal to or lower than the first threshold value and when rotation speed Ne of engine 100 is equal to or lower than the second threshold value, control unit 304 selects the first mode and controls motor 220 and actuator 232. It is noted that, when control unit 304 selected the first mode and start of engine 100 failed, control unit 304 may select the first mode and control actuator 232 and motor 220 such that engine 100 starts after it stops drive of motor 220.

[Description of Operation Mode of Starter]

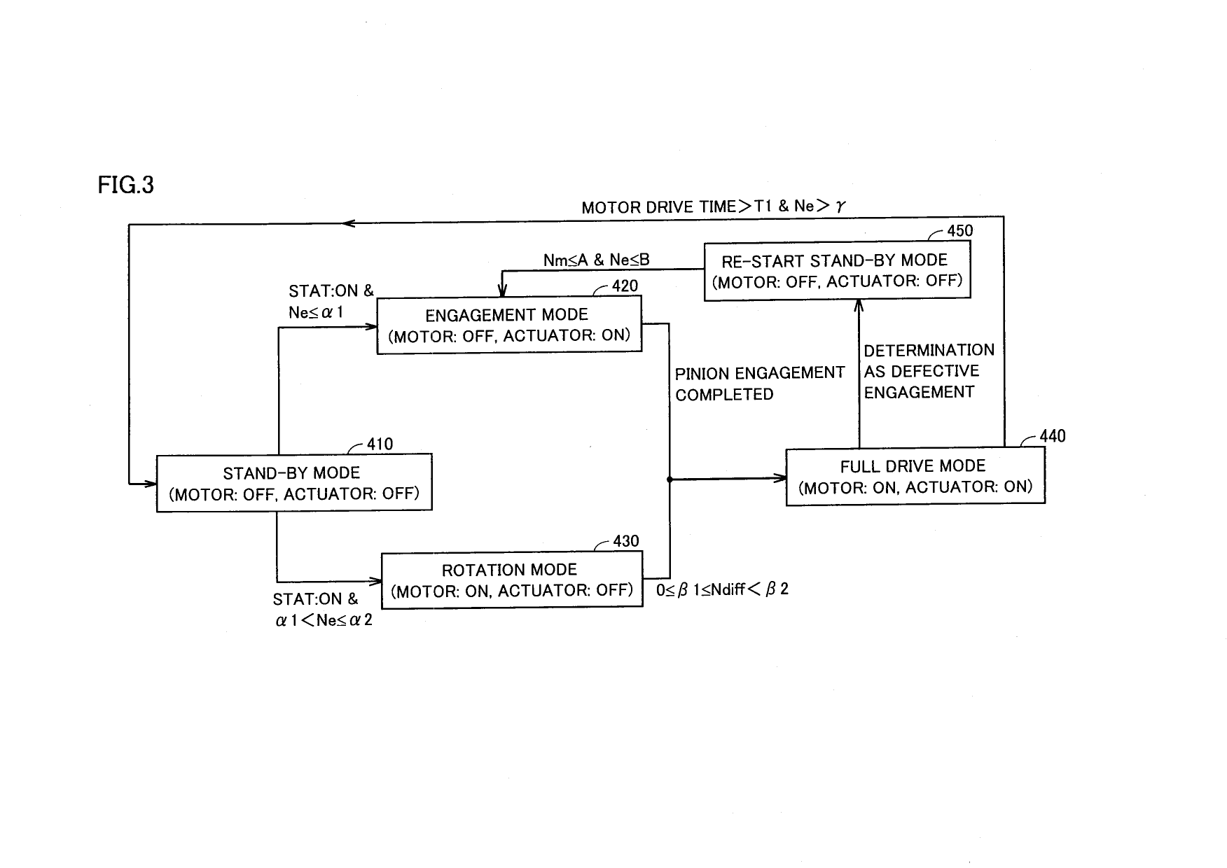

FIG. 3 is a diagram for illustrating transition of an operation mode of starter 200 in the present embodiment. The operation mode of starter 200 in the present embodiment includes a stand-by mode 410, an engagement mode 420, a rotation mode 430, a full drive mode 440, and a re-start stand-by mode 450.

The first mode described previously is a mode in which transition to full drive mode 440 is made via engagement mode 420. The second mode described previously is a mode in which transition to full drive mode 440 is made via rotation mode 430.

Stand-by mode 410 is a mode in which drive of both of actuator 232 and motor 220 in starter 200 is stopped, and it is a mode selected when start of engine 100 is not requested. Stand-by mode 410 corresponds to an initial state of starter 200, and it is selected when drive of starter 200 is not necessary, for example, before an operation to start engine 100, after completion of start of engine 100, failure in starting engine 100, and the like.

Full drive mode 440 is a mode in which both of actuator 232 and motor 220 in starter 200 are driven. When this full drive mode 440 is selected, motor 220 and actuator 232 are controlled such that pinion gear 260 rotates while pinion gear 260 and ring gear 110 are engaged with each other. Thus, engine 100 is actually cranked and the operation for start is started.

Re-start stand-by mode 450 is a mode in which drive of both of actuator 232 and motor 220 in starter 200 is stopped, and it is a mode selected when the second mode has been selected and motor 220 and actuator 232 have been controlled such that the engine starts and when start of engine 100 has failed.

As described above, starter 200 in the present embodiment can independently drive each of actuator 232 and motor 220. Therefore, in a process of transition from stand-by mode 410 to full drive mode 440, there are a case where actuator 232 is driven prior to drive of motor 220 (that is, corresponding to engagement mode 420) and a case where motor 220 is driven prior to drive of actuator 232 (that is, corresponding to rotation mode 430).

Selection between these engagement mode 420 and rotation mode 430 is basically made based on rotation speed Ne of engine 100 when re-start of engine 100 is requested.

Engagement mode 420 refers to a state where only actuator 232 out of actuator 232 and motor 220 is driven and motor 220 is not driven. This mode is selected when pinion gear 260 and ring gear 110 can be engaged with each other even while pinion gear 260 remains stopped. Specifically, while engine 100 remains stopped or while rotation speed Ne of engine 100 is sufficiently low (Ne≦first reference value α1), this engagement mode 420 is selected.

After a signal requesting start of engine 100 is generated, engagement mode 420 is selected for actuator 232 and motor 220.

Then, after engagement mode 420 is selected as the operation mode, the operation mode makes transition from engagement mode 420 to full drive mode 440. Namely, full drive mode 440 is selected and actuator 232 and motor 220 are controlled. Namely, in the present embodiment, based on lapse of a predetermined period of time since start of drive of actuator 232, it is determined that engagement of pinion gear 260 and ring gear 110 with each other has been completed.

Meanwhile, rotation mode 430 refers to a state where only motor 220 out of actuator 232 and motor 220 is driven and actuator 232 is not driven. This mode is selected, for example, when a request for re-start of engine 100 is output immediately after stop of engine 100 is requested and when rotation speed Ne of engine 100 is relatively high (α1<Ne≦a second reference value α2).

When a signal requesting start of engine 100 is generated, actuator 232 and motor 220 are controlled in rotation mode 430.

Thus, when rotation speed Ne of engine 100 is high, difference in speed between pinion gear 260 and ring gear 110 is great while pinion gear 260 remains stopped, and engagement between pinion gear 260 and ring gear 110 may become difficult. Therefore, in rotation mode 430, only motor 220 is driven prior to drive of actuator 232, so that rotation speed Ne of ring gear 110 and a rotation speed of pinion gear 260 are in synchronization with each other. Then, when it is determined that synchronization has been established in response to difference between rotation speed Ne of ring gear 110 and the rotation speed of pinion gear 260 being sufficiently small, actuator 232 is driven and ring gear 110 and pinion gear 260 are engaged with each other. Then, the operation mode makes transition from rotation mode 430 to full drive mode 440.

In the present embodiment, determination of establishment of synchronization is specifically made based on whether or not a relative rotation speed Ndiff between rotation speed Ne of engine 100 and a rotation speed of pinion gear 260 (rotation speed Nm of motor 220 converted to a crankshaft speed) (=Ne−Nm) is in between prescribed threshold values (0≦β1≦Ndiff<β2). Though determination of establishment of synchronization can also be made based on whether or not an absolute value of relative rotation speed Ndiff is smaller than a threshold value β(|Ndiff|<β), engagement is more preferably carried out while rotation speed Ne of engine 100 is higher than the rotation speed of pinion gear 260.

In the case of full drive mode 440, the operation mode returns from full drive mode 440 to stand-by mode 410 in response to completion of start of engine 100 and start of a self-sustained operation of engine 100. When transition to full drive mode 440 is made via rotation mode 430, transition to re-start stand-by mode 450 is made in response to failure of start of engine 100. It is noted that, even when transition to full drive mode 440 via engagement mode 420 is made, transition to re-start stand-by mode 450 may be made in response to failure of start of engine 100.

In the case where re-start stand-by mode 450 is selected, selection of re-start stand-by mode 450 is maintained until rotation speed Nm of motor 220 is equal to or lower than a threshold value A and rotation speed Ne of engine 100 is equal to or lower than a threshold value B, and transition to engagement mode 420 (the first mode) is made when rotation speed Nm of motor 220 is equal to or lower than threshold value A and rotation speed Ne of engine 100 is equal to or lower than threshold value B.

Thus, when a signal requesting start of engine 100 is output, that is, when it is determined that engine 100 is to be started, actuator 232 and motor 220 are controlled in any one mode of the first mode in which transition to full drive mode 440 is made via engagement mode 420 and the second mode in which transition to full drive mode 440 is made via rotation mode 430.

In addition, when transition to full drive mode 440 via rotation mode 430 is made and when start of engine 100 has failed, actuator 232 and motor 220 are controlled such that transition again to engagement mode 420 via re-start stand-by mode 450 is made and engine 100 is started.

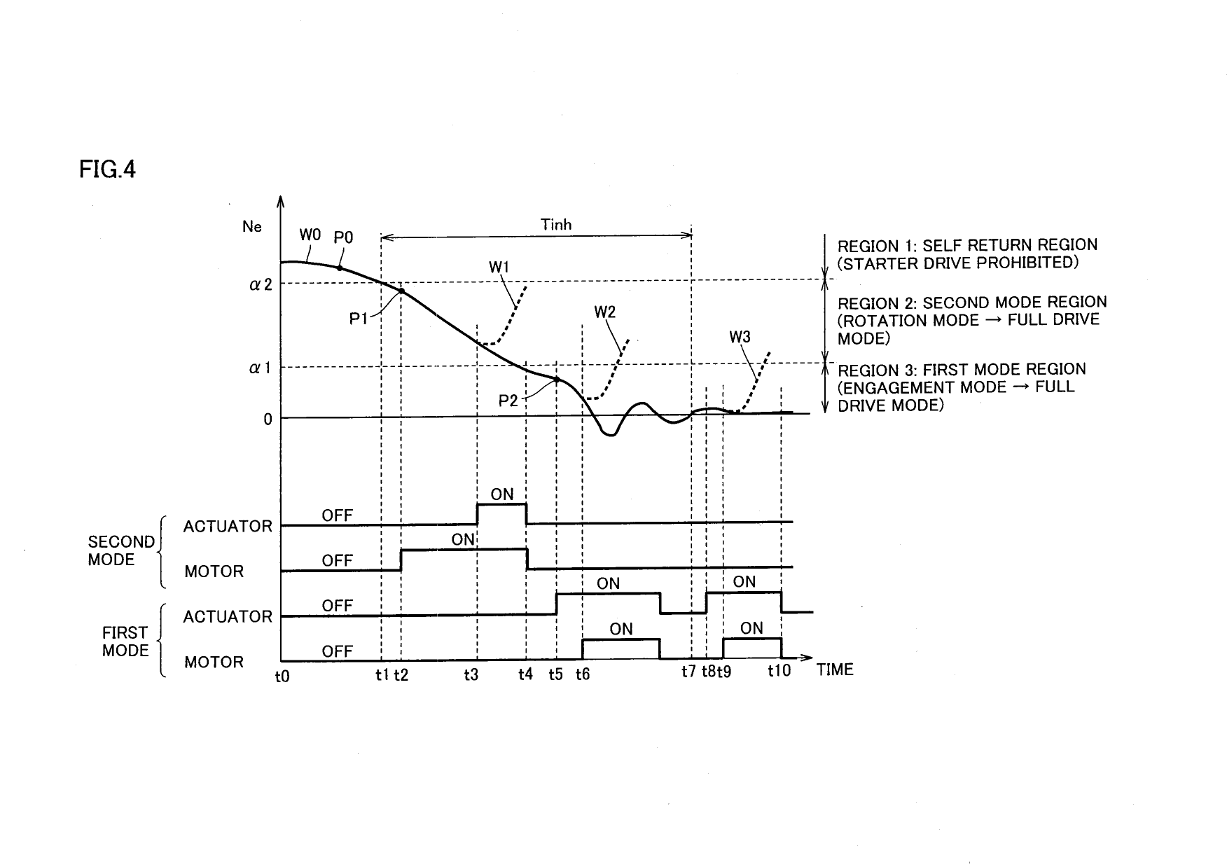

FIG. 4 is a diagram for illustrating engine start control in two drive modes (the first mode, the second mode) selected in an engine start operation in the present embodiment.

In FIG. 4, the abscissa indicates time and the ordinate indicates rotation speed Ne of engine 100 and a state of drive of actuator 232 and motor 220 in the first mode and the second mode.

A case where, at a time t0, for example, a condition that vehicle 10 stops and the driver operates brake pedal 150 is satisfied and consequently a request to stop engine 100 is generated and combustion in engine 100 is stopped is assumed. Here, unless engine 100 is re-started, rotation speed Ne of engine 100 gradually lowers as shown with a solid curve W0 and finally rotation of engine 100 stops.

Then, a case where, for example, an amount of the driver's operation of brake pedal 150 attains to zero while rotation speed Ne of engine 100 is lowering, and thus a request to re-start engine 100 is generated is considered. Here, categorization into three regions based on rotation speed Ne of engine 100 is made.

A first region (region 1) refers to a case where rotation speed Ne of engine 100 is higher than second reference value α2, and for example, such a state that a request for re-start is generated at a point P0 in FIG. 4.

This region 1 is a region where engine 100 can be started by a fuel injection and ignition operation without using starter 200 because rotation speed Ne of engine 100 is sufficiently high. Namely, region 1 is a region where engine 100 can return by itself. Therefore, in region 1, drive of starter 200 is prohibited. It is noted that second reference value α2 described above may be restricted depending on a maximum rotation speed of motor 220.

A second region (region 2) refers to a case where rotation speed Ne of engine 100 is located between first reference value α1 and second reference value α2, and such a state that a request for re-start is generated at a point P1 in FIG. 4.

This region 2 is a region where rotation speed Ne of engine 100 is relatively high, although engine 100 cannot return by itself. In this region, the rotation mode (the second mode) is selected as described with reference to FIG. 3.

When a request to re-start engine 100 is generated at a time t2, ECU 300 initially drives motor 220. Thus, pinion gear 260 starts to rotate.

At a time t3, actuator 232 is driven. Then, when ring gear 110 and pinion gear 260 are engaged with each other, engine 100 is cranked and rotation speed Ne of engine 100 increases as shown with a dashed curve W1. Thereafter, when engine 100 resumes the self-sustained operation, drive of actuator 232 and motor 220 is stopped.

A third region (region 3) refers to a case where rotation speed Ne of engine 100 is lower than first reference value α1, and for example, such a state that a request for re-start is generated at a point P2 in FIG. 4.

This region 3 is a region where rotation speed Ne of engine 100 is low and pinion gear 260 and ring gear 110 can be engaged with each other without synchronizing pinion gear 260. In this region, the engagement mode is selected as described with reference to FIG. 3.

When a request to re-start engine 100 is generated at a time t5, ECU 300 initially drives actuator 232. Thus, pinion gear 260 is pushed toward ring gear 110. At a time t6, when engagement between ring gear 110 and pinion gear 260 is completed after drive of actuator 232, motor 220 is driven. Thus, engine 100 is cranked and rotation speed Ne of engine 100 increases as shown with a dashed curve W2. Thereafter, when engine 100 resumes the self-sustained operation, drive of actuator 232 and motor 220 is stopped.

By thus controlling re-start of engine 100 by using starter 200 in which actuator 232 and motor 220 can independently be driven, engine 100 can be re-started in a shorter period of time than in a case of a conventional starter where an operation to re-start engine 100 was prohibited during a period (Tinh) from a rotation speed at which return of engine 100 by itself was impossible (time t1 in FIG. 4) to stop of engine 100 (a time t7 in FIG. 4). Thus, the driver's uncomfortable feeling due to delayed re-start of the engine can be lessened.

Furthermore, when such a state that a value calculated by subtracting rotation speed Ne of engine 100 from rotation speed Nm of motor 220 (Nm−Ne) is greater than predetermined value Nerr has continued for a predetermined period of time in the case where the second mode has been selected and when motor 220 and actuator 232 have been operating in parallel since time t3, it is determined that start of engine 100 failed. Therefore, the re-start stand-by mode is selected and drive of actuator 232 and motor 220 is stopped.

The re-start stand-by mode is selected until rotation speed Nm of motor 220 is equal to or lower than threshold value A and rotation speed Ne of engine 100 is equal to or lower than threshold value B, and the first mode is selected when rotation speed Nm of motor 220 is equal to or lower than threshold value A and rotation speed Ne of engine 100 is equal to or lower than threshold value B at a time t8.

Namely, as the engagement mode is selected, ECU 300 initially drives actuator 232 to thereby push pinion gear 260 toward ring gear 110. When engagement between ring gear 110 and pinion gear 260 is completed at a time t9 after actuator 232 is driven, the full drive mode is selected so that motor 220 is driven.

Thus, engine 100 is cranked and rotation speed Ne of engine 100 increases as shown with a dashed curve W3. Thereafter, when engine 100 operates to rotate in a self-sustained manner, drive of actuator 232 and motor 220 is stopped at a time t10.

[Description of Operation Mode Setting Control]

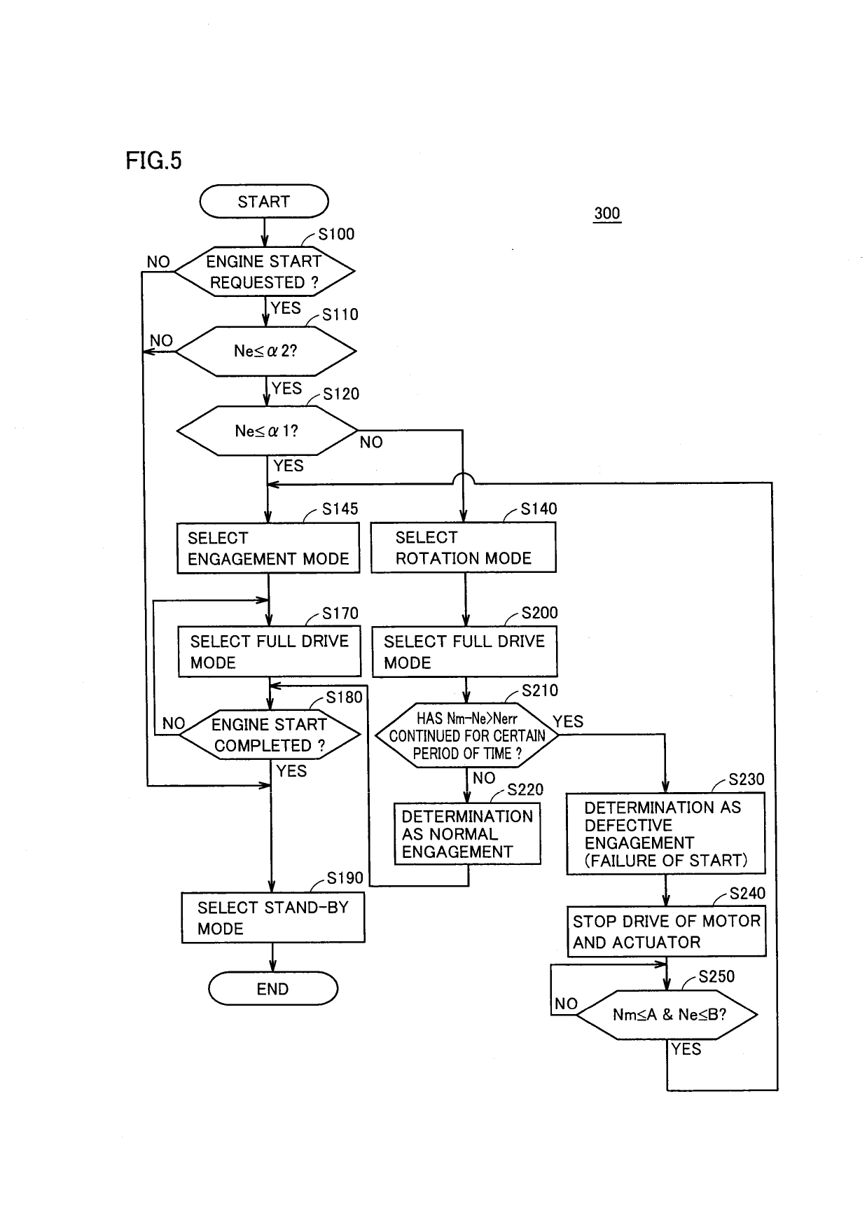

FIG. 5 is a flowchart for illustrating details of operation mode setting control processing performed by ECU 300 in the present embodiment. The flowchart shown in FIG. 5 is realized by executing a program stored in advance in a memory of ECU 300 in a prescribed cycle. Alternatively, regarding some steps, processing can also be performed by constructing dedicated hardware (electronic circuitry).

Referring to FIGS. 1 and 5, in step (hereinafter the step being abbreviated as S) 100, ECU 300 determines whether or not start of engine 100 has been requested.

When start of engine 100 has not been requested (NO in S100), ECU 300 causes the process to proceed to S190 and selects the stand-by mode because an operation to start engine 100 is not necessary.

When start of engine 100 has been requested (YES in S100), the process proceeds to S110 and ECU 300 then determines whether or not rotation speed Ne of engine 100 is equal to or smaller than second reference value α2.

When rotation speed Ne of engine 100 is greater than second reference value α2 (NO in S110), this case corresponds to region 1 in FIG. 4 where engine 100 can return by itself. Therefore, ECU 300 causes the process to proceed to S190 and selects the stand-by mode.

When rotation speed Ne of engine 100 is equal to or smaller than second reference value α2 (YES in S110), ECU 300 further determines whether or not rotation speed Ne of engine 100 is equal to or smaller than first reference value α1.

When rotation speed Ne of engine 100 is equal to or smaller than first reference value α1 (YES in S120), this case corresponds to region 1 in FIG. 4. Therefore, the process proceeds to S145 and ECU 300 selects the engagement mode. Then, ECU 300 outputs control signal SE1 so as to close relay RY1, and thus actuator 232 is driven. Here, motor 220 is not driven.

Thereafter, the process proceeds to S170 and ECU 300 selects the full drive mode. Then, starter 200 starts cranking of engine 100.

Then, in S180, ECU 300 determines whether or not start of engine 100 has been completed. Determination of completion of start of engine 100 may be made, for example, based on whether or not the rotation speed of engine 100 is greater than a threshold value γ indicating the self-sustained operation after lapse of a prescribed period of time since start of drive of motor 220.

When start of engine 100 has not been completed (NO in S180), the process returns to S170 and cranking of engine 100 is continued.

When start of engine 100 has been completed (YES in S180), the process proceeds to S190 and ECU 300 selects the stand-by mode.

On the other hand, when rotation speed Ne of engine 100 is greater than first reference value α1 (NO in S120), the process proceeds to S140 and ECU 300 selects the rotation mode. Then, ECU 300 outputs control signal SE2 so as to close relay RY2, and thus motor 220 is driven. Here, actuator 232 is not driven.

Then, ECU 300 selects the full drive mode in S200. Thus, actuator 232 is driven, pinion gear 260 and ring gear 110 are engaged with each other, and engine 100 is cranked.

Then, in S210, ECU 300 determines whether or not a state in which a difference (Nm−Ne) between rotation speed Nm of motor 220 and rotation speed Ne of engine 100 is out of the predetermined range (that is, a state in which the difference is greater than predetermined value Nerr) has continued for a predetermined period of time since start of drive of motor 220. When the state in which the difference between rotation speed Nm of motor 220 and rotation speed Ne of engine 100 is greater than predetermined value Nerr has continued for a predetermined period of time since start of drive of motor 220 (YES in S210), ECU 300 determines in S230 that engagement between pinion gear 260 and ring gear 110 has failed and start of engine 100 has failed.

Then, in S240, ECU 300 stops drive of motor 220 and actuator 232. Thereafter, the process proceeds to S250, where ECU 300 determines whether or not rotation speed Nm of motor 220 is equal to or lower than a predetermined value A and rotation speed Ne of engine 100 is equal to or lower than a predetermined value B. When ECU 300 determines that rotation speed Nm of motor 220 is equal to or lower than predetermined value A and rotation speed Ne of engine 100 is equal to or lower than predetermined value B (YES in S250), the process returns to S145, where ECU 300 selects the engagement mode. When rotation speed Nm of motor 220 is greater than predetermined value A or rotation speed Ne of engine 100 is greater than predetermined value B (NO in S250), ECU 300 returns the process to S250 and stands by.

When the difference between rotation speed Nm of motor 220 and rotation speed Ne of engine 100 becomes equal to or lower than predetermined value Nerr by the time of lapse of a predetermined period of time since start of drive (NO in S210), ECU 300 determines in S220 that pinion gear 260 and ring gear 110 have normally been engaged with each other, and the process proceeds to S180, where ECU 300 determines whether or not start of engine 100 has completed.

As described above, in the present embodiment, when the second mode is selected in response to the request to start the engine and when start of the engine fails, the first mode is selected and the actuator and the motor are controlled such that the engine starts after drive of the motor and the actuator is stopped. By doing so, when start of the engine is completed in the second mode, the engine can be started promptly even when the rotation speed of the engine is high. In addition, when start of the engine has failed in the second mode, the engine can reliably be started in the first mode, and hence deterioration in engine starting capability can be suppressed. Therefore, a control device for a starter and a method of controlling a starter for suppressing deterioration in engine starting capability can be provided.

Though description has been given in the present embodiment assuming that drive of the motor and the actuator is stopped when the second mode is selected and start of the engine fails, drive of at least only the motor out of the motor and the actuator may be stopped.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

10 vehicle; 100 engine; 110 ring gear; 111 crankshaft; 115 rotation speed sensor; 120 battery; 125 voltage sensor; 127 DC/DC converter; 130 voltage sensor; 140 accelerator pedal; 150 brake pedal; 200 starter; 210 plunger; 220 motor; 230 solenoid; 232 actuator; 240 coupling portion; 245 fulcrum; 250 output member; 260 pinion gear; 300 ECU; 302 determination unit; and 304 control unit.

1-6. (canceled)

7. A control device for a starter for starting an engine, said starter including a second gear that can be engaged with a first gear coupled to a crankshaft of said engine, an actuator for moving said second gear to a position of engagement with said first gear in a driven state, and a motor for rotating said second gear, said control device being capable of individually driving each of said actuator and said motor, comprising:
a rotation mode in which said motor is driven prior to drive of said actuator; and
an engagement mode in which said second gear is engaged with said first gear by driving said actuator prior to drive of said motor, wherein
when start of said engine failed in said rotation mode, said control device controls said actuator and said motor such that said engine starts, by lowering a rotation speed of said motor by stopping drive of said motor and selecting said engagement mode as the rotation speed of said motor becomes equal to or lower than a predetermined value.

8. The control device for a starter according to claim 7, wherein
said control device controls said actuator and said motor such that said engine starts in said engagement mode when such a condition for allowing engagement between said first gear and said second gear that a rotation speed of said motor is equal to or lower than a first threshold value and a rotation speed of said engine is equal to or lower than a second threshold value is satisfied.

9. The control device for a starter according to claim 8, wherein
said control device selects said rotation mode when the rotation speed of said engine is higher than a reference value in a case where a request for starting said engine is issued and selects said engagement mode when the rotation speed of said engine is lower than said reference value in a case where the request for starting said engine is issued.

10. The control device for a starter according to claim 7, wherein
said control device determines that start of said engine failed when such a state that a difference between a rotation speed of said motor and a rotation speed of said engine is out of a predetermined range has continued for a predetermined period of time while said motor and said actuator have been operating.

11. The control device for a starter according to claim 10, wherein
said control device selects said rotation mode when the rotation speed of said engine is higher than a reference value in a case where a request for starting said engine is issued and selects said engagement mode when the rotation speed of said engine is lower than said reference value in a case where the request for starting said engine is issued.

12. A control device for a starter for starting an engine, said starter including a second gear that can be engaged with a first gear coupled to a crankshaft of said engine, an actuator for moving said second gear to a position of engagement with said first gear in a driven state, and a motor for rotating said second gear, said control device being capable of individually driving each of said actuator and said motor, comprising:
a rotation mode in which said motor is driven prior to drive of said actuator; and
an engagement mode in which said second gear is engaged with said first gear by driving said actuator prior to drive of said motor, wherein
when such a state that a difference between a rotation speed of said motor and a rotation speed of said engine is out of a predetermined range has continued for a predetermined period of time while said motor and said actuator have been operating in said rotation mode, said control device controls said actuator and said motor such that said engine starts, by lowering the rotation speed of said motor by stopping drive of said motor and selecting said engagement mode as the rotation speed of said motor becomes equal to or lower than a predetermined value.

13. The control device for a starter according to claim 12, wherein
said control device controls said actuator and said motor such that said engine starts in said engagement mode when such a condition for allowing engagement between said first gear and said second gear that a rotation speed of said motor is equal to or lower than a first threshold value and a rotation speed of said engine is equal to or lower than a second threshold value is satisfied.

14. The control device for a starter according to claim 13 wherein
said control device selects said rotation mode when the rotation speed of said engine is higher than a reference value in a case where a request for starting said engine is issued and selects said engagement mode when the rotation speed of said engine is lower than said reference value in a case where the request for starting said engine is issued.

15. A method of controlling a starter, said starter including a second gear that can be engaged with a first gear coupled to a crankshaft of an engine, an actuator for moving said second gear to a position of engagement with said first gear in a driven state, and a motor for rotating said second gear, each of said actuator and said motor being able to individually be driven, comprising the steps of:
driving said actuator and said motor in a rotation mode in which said motor is driven prior to drive of said actuator;
driving said actuator and said motor in an engagement mode in which said second gear is engaged with said first gear by driving said actuator prior to drive of said motor; and
controlling said actuator and said motor such that said engine starts, by lowering a rotation speed of said motor by stopping drive of said motor and selecting said engagement mode as the rotation speed of said motor becomes equal to or lower than a predetermined value, when start of said engine failed in said rotation mode.
